(19) United States
(12) Patent Application Publication
(10) Pub. No.: US 2002/0046109 A1
(43) Pub. Date: Apr. 18, 2002

(54) Method and system for administering a customer loyalty reward program using a browser extension

(76) Inventors: Huw Leonard, Missisauga (CA); Gary Farmaner, Toronto (CA)

Correspondence Address: MORGAN & FINNEGAN, L.L.P., 345 Park Avenue, New York, NY, 10154-0053, US

(21) Appl. No.: 09/908,615

(22) Filed: Jul. 19, 2001

Related U.S. Application Data
(60) Provisional application No. 60/220,462, filed on Jul. 24, 2000.

(51) Int. Cl. G06F 17/60

(52) U.S. Cl. 705/14; 705/26

(57) ABSTRACT

A system and method are provided for administering an on-line customer loyalty reward program through the use of a browser extension installed on a client computer system. The browser extension is capable of detecting special text (e.g., Extensible Markup Language (“XML”)) embedded in a comment block or data island of a HyperText Markup Language (“HTML”) document, which embedded text may be dynamically generated by a server computer system to describe an on-line purchase, or statically created to identify and describe electronic coupons (“e-Coupons”) or other promotions. The browser extension processes the special text (e.g., XML) to register e-Coupons and/or on-line purchases in the customer loyalty reward program. One or more registered e-Coupons may be automatically applied to any applicable on-line purchase.

### CROSS-REFERENCE TO RELATED APPLICATION

This application claims the benefit of U.S. Provisional Application No. 60/220,462, filed Jul. 24, 2000.

### BACKGROUND OF THE INVENTION

1. Field of the Invention

The present invention relates to systems for administering customer loyalty reward programs and, in particular, to a method and system for administering a customer loyalty reward program over a computer network, such as the Internet, through the use of a browser extension or other software application program.

2. Description of the Related Art

Programs to promote customer loyalty are well known. An example of such a program is a “frequent flyer” reward program where a consumer, who is a member of the reward program, is awarded “points” or “frequent flyer miles” for traveling with a particular airline or purchasing goods or services associated with that airline. After the consumer has accumulated a specified number of points or miles, the consumer may redeem the accumulated points or miles for a benefit or reward offered under the program, such as a free airline ticket, rental car, hotel room, or cash discounts on goods or services offered by the airline or participating establishments.

Another example of a customer loyalty program is that currently being offered by the issuers of credit cards or other credit instruments where “points” are awarded based upon the dollar amount of purchases on the credit card. The consumer, who is a member of the customer loyalty program, may accumulate and redeem these points for a reward offered in the program. Depending on the program, the consumer may be permitted to transfer the accumulated “points” to the consumer's frequent flyer program for the purpose of redeeming an award from the airline offering the frequent flyer program.

Yet another example of a customer loyalty reward program involves offering coupons, cash discounts, instantaneous rewards, or other promotions to members of the program for purchasing particular goods or services from one or more merchants participating in the customer loyalty reward program.

With the advent of the Internet—a vast number of computers and computer networks that are interconnected through communication links—e-commerce purchases of goods and services on-line from e-commerce retailers (“e-retailers”) or merchants have created a rapidly growing market for implementing and administering on-line customer loyalty reward programs. Accordingly, there is a need for an on-line system and method for administering customer loyalty reward programs that provides easy access to consumers making purchases over the Internet or other computer network using conventional computer hardware and software, which also permits sponsors and merchants to readily and efficiently support such customer loyalty reward programs.

### SUMMARY OF THE INVENTION

In accordance with one embodiment of the present invention, a system and method are provided for administering an on-line customer loyalty reward program through the use of a browser extension installed on a consumer or user's client computer system. The browser extension is capable of detecting and processing dynamically generated purchase-descriptive text (e.g., Extensible Markup Language (“XML”)) embedded in a comment block or data island of a HyperText Markup Language (“HTML”) document generated by a merchant's server computer system. The browser extension processes the purchase-descriptive text (e.g., XML) to register the purchase in the customer loyalty reward program.

In accordance with another embodiment of the present invention, a system and method are provided for administering a customer loyalty reward program by distributing, registering and redeeming electronic coupons (“e-Coupons”) through the use of a browser extension installed on a consumer or user's client computer system. The e-Coupon contains embedded XML or other special text describing the coupon or other promotion that may be detected and processed by the browser extension. The browser extension detects, registers and processes the XML to allow the user to accept, store and ultimately redeem the e-Coupon from one or more merchants participating in the customer loyalty reward program.

The foregoing specific objects and advantages of the invention are illustrative of those that can be achieved by the present invention and are not intended to be exhaustive or limiting of the possible advantages that can be realized. Thus, these and other objects and advantages of this invention will be apparent from the description herein or can be learned from practicing this invention, both as embodied herein or as modified in view of any variations that may be apparent to those skilled in the art. Accordingly, the present invention resides in the novel parts, constructions, arrangements, combinations and improvements herein shown and described.

### BRIEF DESCRIPTION OF DRAWINGS

The foregoing features and other aspects of the invention are explained in the following description taken in connection with the accompanying drawings, wherein:

FIG. 1 is a block diagram of a computer network environment in which a preferred embodiment of the present invention may be implemented and practiced;

FIG. 2 is a representative illustration of a client computer system communicating over a computer network with a server computer system in accordance with a preferred embodiment of the present invention;

FIG. 3 is a diagram illustrating a full screen image of the preferred lay-out of a browser extension within a browser on a client computer system in accordance with the present invention;

FIG. 4 is a diagram illustrating the preferred lay-out of the browser extension of FIG. 3;

FIG. 5 is a flow diagram illustrating the steps associated with detecting and registering a participating user's on-line purchase for a customer loyalty reward program in accordance with a preferred embodiment of the present invention;

FIG. 6 is a flow diagram illustrating the steps associated with detecting and registering a participating user's on-line purchase for a customer loyalty reward program in accordance with a second preferred embodiment of the present invention; and

FIG. 7 is a flow diagram illustrating the steps associated with distributing, registering and redeeming electronic coupons in accordance with another preferred embodiment of the present invention.

### DETAILED DESCRIPTION

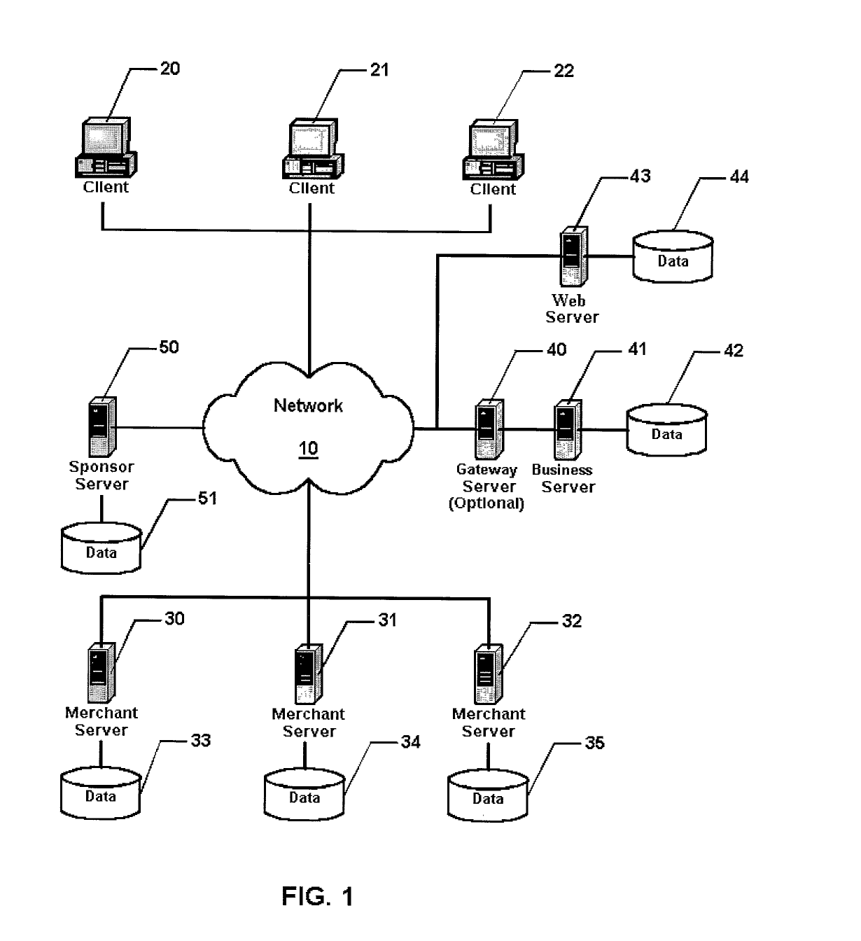

With reference to the drawings and in particular to FIG. 1, there is illustrated a computer network 10, such as the Internet, in which a preferred embodiment of the present invention may be implemented and practiced. While the present invention is described below as being implemented via the Internet, it is understood that the present invention is not limited to use with the Internet and may be implemented in a wide variety of other computer networks (e.g., Intranet, LAN, or combinations thereof).

The term “Internet” is actually an abbreviation for “Internetwork” and is understood by those skilled in the art to comprise a vast array of computers, computer networks and gateways that are interconnected through communication links. The interconnected computers exchange and transfer electronic information using various services, such as the World Wide Web (“WWW”). The WWW is a collection of server computer systems 30, 31, 32, 40, 43, 50 on the Internet that utilize the functionality provided by HyperText Transfer Protocol (HTTP″)—a conventional application protocol that facilitates data exchange between client and server computer systems, and provides users of client computer systems 20, 21, 22 with access to electronic files or Web “pages” that may include text, graphics, sound and/or video using a standard page description language referred to as HyperText Markup Language (“HTML”). Thus, the WWW allows a server computer system 30, 31, 32, 41, 43, 50 (e.g., Web server or Web site) to transmit text and graphical Web “pages” of electronic information to a remote client computer system 20, 21, 22 so that the client computer system 20, 21, 22 may then display the Web “pages.” This is commonly referred to as a client/server architecture.

The Internet also provides client computer systems 20, 21, 22 with access to other forms of data using various exchange protocols different from HTTP. In this way, various private communication schemes may be established between client computer systems 20, 21, 22 and special-purpose server computer systems 40, 41 (e.g., a software Gateway).

A user of a client computer system 20, 21, 22 may access and use the Internet by establishing a network connection through the services of an Internet Service Provider (“ISP”). An ISP allows computer users to dial a telephone number using a computer modem or other communication interface to establish a connection between the client computer system 20, 21, 22 and a remote computer system (not shown) owned or managed by the ISP.

The client computer systems 20, 21, 22 and server computer systems 30, 31, 32, 40, 41, 43, 50 may communicate with one another utilizing the functionality provided by HTTP and other Internet protocols. A client computer system 20, 21, 22 and server computer system 30, 31, 32, 40, 41, 43, 50 may preferably be coupled to one another via Transfer Control Protocol/Internet Protocol (“TCP/IP”). The WWW includes all the server computer systems 30, 31, 32, 40, 43, 50 adhering to this HTTP standard that are accessible to client computer systems 20, 21, 22. The Internet includes all the server computer systems 30, 31, 32, 40, 43, 50 adhering to any Internet protocol that are accessible to the client computer systems 20, 21, 22 via TCP/IP.

The server computer systems 30, 31, 32, 40, 41, 43, 50 preferably include certain standard hardware components, such as a processing unit, microprocessor or central processing unit (collectively referred hereinafter as “CPU”), a random-access memory (“RAM”), a read-only memory (“ROM”), a clock, a data storage device and a communications port. The CPU is preferably linked to each of the other listed elements, either by means of a shared data bus or dedicated connections. The communications port facilitates connection of the server computer system 30, 31, 32, 40, 41, 43, 50 to client and/or server computer systems, and may include multiple communication channels for simultaneously establishing a plurality of connections. The server computer systems 30, 31, 32, 40, 41, 43, 50 illustrated in FIG. 1 may include and be operable with an accompanying data storage device 33, 34, 35, 42, 44, 51 for storing data, electronic files, application software, rules, subroutines, or other information for that particular server computer system. Those skilled in the art will appreciate that the computer hardware described above may vary for specific applications and that the present invention is not intended to be limited to the abovedescribed computer hardware.

In the illustrative embodiment shown in FIG. 1, merchant server computer systems 30, 31, 32 represent the server computer systems associated with an on-line merchant (“e-retailer”) that may or may not be a participating merchant or e-retailer in the on-line customer loyalty reward program. The merchant server computer systems 30, 31, 32 permit merchants to conduct electronic commerce (“e-commerce”) by advertising and selling goods or services over the WWW. The goods or services may include merchandise that is delivered electronically to the purchaser over the Internet (e.g., music) and/or merchandise that is delivered to the purchaser through conventional distribution channels (e.g., books). A merchant server computer system 30, 31, 32 may provide an electronic version of a catalog that identifies or displays the goods or services that are available to the user of a client computer system 20, 21, 22. As discussed in greater detail below, a consumer or user using a client computer system 20, 21, 22 may communicate with the merchant server computer system 30, 31, 32 via computer network 10 (e.g., the Internet) to browse and/or purchase goods or services offered for sale by the operator (“e-retailer”) of the merchant server computer system 30, 31, 32.

In the preferred embodiment of the present invention, business server computer system 41 represents the computer system associated with the manager of the on-line customer loyalty reward program. Similarly, in the preferred embodiment of the present invention, sponsor server computer system 50 represents the server computer system associated with the sponsor of the customer loyalty reward program (e.g., an airline offering a frequent flyer program or an issuer of a credit card offering a customer loyalty reward program).

In the preferred embodiment illustrated in FIG. 1, an optional gateway server computer system 40 is shown for connecting business server computer system 41 to computer network 10 and to the client/server computer systems 20, 21, 22, 30, 31, 32, 43, 50. In many circumstances, the nature of data on database 42 may require the business server computer system 41 to be isolated from the client/server computer systems 20, 21, 22, 30, 31, 32, 43, 50 using TCP/IP. This serves to protect the data stored within database 42 from inappropriate and unauthorized access through known and currently unknown security flaws in the operating system running on the business server computer system 41. The gateway server computer system 40 essentially acts as a “middleman” exchanging data between the business server computer system 41 and the client/server computer systems 20, 21, 22, 30, 31, 32, 43, 50. The gateway server computer system 40 exchanges only a limited and known set of messages in very specific formats, and can do various types of intrusion detection and response to help protect the data in database 42 from inappropriate and unauthorized access.

An optional web server computer system 43 is also illustrated in FIG. 1. Like the business server computer system 41, the web server computer system 43 is also associated with the manager of the on-line customer loyalty reward program. The optional web server computer system 43 preferably uses HTTP protocol. Thus, should the business server computer system 41 be isolated from the client/server computer systems 20, 21, 22, 30, 31, 32, 50 by a gateway server computer system 40 as shown in FIG. 1, the associated web server computer system 43 may optionally be provided to communicate with the client/server computer systems 20, 21, 22, 30, 31, 32, 50 using the HTTP protocol. In this manner, the manager of the customer loyalty reward program may, for example, transmit HTML “pages” or other information from the web server computer system 43 to the client server computer systems 20, 21, 22. In addition, the business server computer system 41 may preferably communicate directly with the optional web server computer system 43 inside or within the “gateway” to, for example, access data stored in the data storage device 44 associated with the web server computer system 43.

While the gateway server computer system 40 is illustrated in FIG. 1 as connecting business server computer system 41 to computer network 10 and to the other computer systems 20, 21, 22, 30, 31, 32, 43, 50, it is understood that business server computer system 41 may not necessarily require a “gateway” and that the present invention may be implemented with or without gateway server computer system 40. It is also understood that the functionality of the web server computer system 43 may be incorporated into the business server computer system 41 or the optional gateway server computer system 40, thereby eliminating the need for a separate web server computer system 43. Similarly, it is also understood that the functionality of the optional gateway server computer system 40 may be incorporated into the business server computer system 41, thereby eliminating the need for a separate gateway server computer system 40.

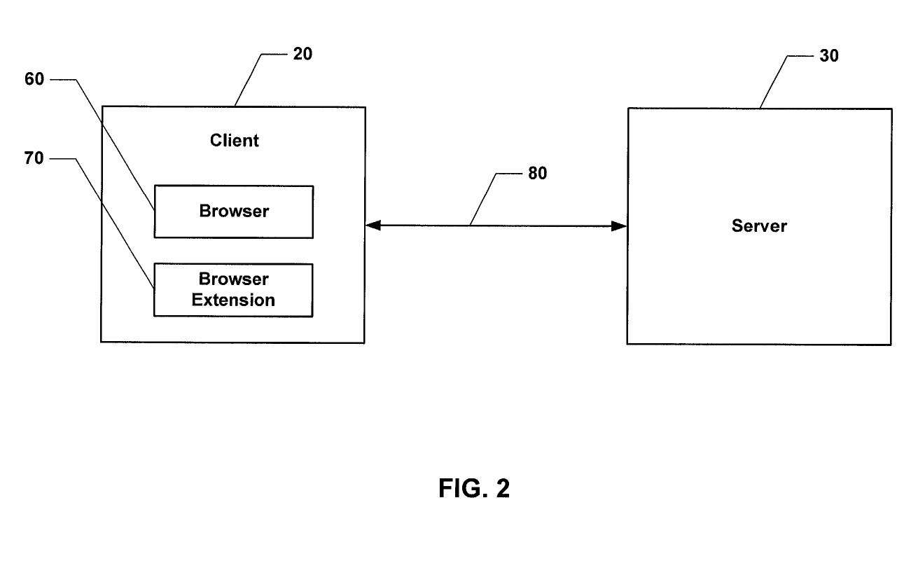

FIG. 2 is a representative illustration of a client computer system 20 communicating via communication link 80 over a computer network (e.g., the Internet) with an exemplary merchant server computer system 30. The communication link 80 represents the communication path (e.g., cable, fiber or wireless links on which electronic signals can propagate, as well as any computer systems and networks used to route and complete the path between the client and server computer systems) through the computer network 10 of FIG. 1.

Though not illustrated, the client computer system 20 is preferably comprised of a processing unit, microprocessor or CPU, a communication device (e.g., a modem), a read-only memory (“ROM”), a random-access memory (“RAM”), an input device (e.g., alphanumeric keyboard and mouse), a video display terminal or monitor, and any software application programs required to communicate with the server computer system 30. Those skilled in the art will appreciate that the computer hardware described above may vary for specific applications and that the present invention is not intended to be limited to the above-described computer hardware. It is also understood that client computer systems 21, 22 (FIG. 1) may be substituted for client computer system 20 and that server computer systems 31, 32, 41, 43, 50 (FIG. 1) may be substituted for server computer system 30.

Referring to FIG. 2, a browser or “Web browser” 60 is installed on the client computer system 20 in a conventional manner. The browser 60 is a special-purpose application program running on the client computer system 20 that affects the requesting and displaying of information to the user on the client computer system 20. Well known browsers 60 that may be utilized with the present invention include Microsoft® Internet Explorer and Netscape Navigator. The server computer system 30 executes a corresponding server application program that presents information over communication link 80 to the client computer system 20 in the form of HTTP responses. The HTTP responses correspond to Web “pages” constructed from HTML or other server generated data.

Each resource (e.g., computer or Web “page”) of the WWW has a unique identification known as a “Uniform Resource Locator” (“URL”). To view a specific Web “page”, a client computer system 20 specifies the URL for the desired Web “page” in a request (e.g., the HTTP request). The request is forwarded over communication link 80 to the server computer system 30 that supports the Web “page.” When that server computer system 30 receives the request, it sends that Web “page” to the client computer system 20 over communication link 80. When the client computer system 20 receives the Web “page”, the client computer system 20 displays the Web “page” on the video display terminal using the browser 60 installed on the client computer system 20.

Currently, Web “pages” are typically defined using HyperText Markup Language (“HTML”), which provides a standard set of tags specifying how a Web page is to be displayed. When a user instructs the browser 60 on the client computer system 20 to display a Web “page” (e.g., specifying a URL associated with the desired Web “page”), the browser 50 sends a request over communication link 80 to the server computer system 30 to transfer to the client computer system 20 a HTML document that defines the Web “page.” When the requested HTML document is received by the client computer system 20, the browser 60 displays the Web “page” as defined by the HTML document on the video display terminal of the client computer system 20. The HTML document contains various tags that control the displaying of text, graphics, controls, and other features. The HTML document may also include links to or URLs for other Web “pages” available on that server computer system 30 or other server computer systems 31, 32, 41, 50.

In addition to the browser 60, a user of a client computer system 20 who is or wishes to be a registered participant in the on-line customer loyalty reward program preferably installs a browser extension, “SmartBar” or “e-Bar” 70 on the user's client computer system 20. In a preferred embodiment of the present invention, the user of the client computer system 20 may download the browser extension 70 to the user's client computer system 20 after registering as a participant in the on-line customer loyalty reward program. That is, the user of the client computer system 20 may preferably communicate over computer network 10 (and optional gateway server computer system 40) with the business server computer system 41 and/or the optional web server computer system 43 to register the user as a participant in the on-line customer loyalty reward program. The user may contact the business server computer system 41 and/or the optional web server computer system 43 in a conventional manner by, for example, typing in the URL associated with the business server computer system 41 or optional web server computer system 43. The user may register as a participant in the on-line customer loyalty reward program by providing user-specific information (e.g., name, post office address, e-mail address, etc.) and, upon successful registration, the business server computer system 41 and/or the optional web server computer system 43 will preferably transmit an electronic file containing the browser extension 70 to be downloaded onto and stored on the user's client computer system 20.

In addition, when the user registers to participate in the customer loyalty reward program, a re-cord for that user is preferably created in the data storage device 42 associated with the business server computer system 41, which re-cord may be used for subsequent registration of the user's qualifying on-line purchases to redeem rewards in the customer reward loyalty program.

The browser extension 70 is preferably an embedded application program that cooperates with the browser 60 on the client computer system 20. The browser extension 70 fully manages the registration of on-line purchases by the user from merchants or e-retailers participating in the customer loyalty reward program (“participating merchants”) and allows the user to obtain rewards for making on-line purchases from participating merchants. The browser extension 70 is preferably an Internet application capable of using various Internet protocols to communicate with other computer systems over the Internet independent of the protocols and communication of the browser 60. The browser extension 70 is preferably a small window embedded within the browser 60 that provides the user of the client computer system 20 with visual content, and also monitors the navigation events and the HTML being displayed to the user on the client computer system 20 to detect when modifications to URLs are required and special text (e.g., Extensible Markup Language (“XML”)) embedded within the HTML document is present.

The browser extension 70 is preferably a “thin-client” in which the majority of the visible content and configuration is stored and maintained by the business server computer system 41 in the data storage device 42 (or optionally by the web server computer system 43 in the data storage device 44). Alternatively, the visible content and configuration of the browser extension 70 may be stored locally on the user's client computer system 20. Some of the advantages of storing this information in the data storage device 42 of the business server computer system 41 are that: (1) the user may install the browser extension 70 on more than one client computer system 20 and automatically obtain the user's current browser extension configuration; (2) the size of the executable browser extension 70 is reduced, thereby increasing the speed of the browser extension 70, and making the browser extension 70 easier to install and update; and (3) the user's information and preferences may be securely maintained in the data storage device 42 of the business server computer system 41, rather than risking the possibility of unauthorized access on the client computer system 20.

The browser extension 70 in accordance with the present invention is preferably a virtualized portal. Rather than requiring a user of a client computer system 20 to link to a merchant's site or Web “page” on a merchant server computer system 30 through a portal, the browser extension 70 can determine/obtain information about the participating merchant's site irrespective of whether the user connects to the merchant server computer system 30 via a search engine, a link in an e-mail message, a banner advertisement on another Web “page”, or by directly typing a URL seen or heard from print, radio or television advertising. It is preferable that the browser extension 70 be capable of informing the user of predefined information regarding a particular site or Web “page” and managing the issues of customer loyalty reward benefits without major modifications to a merchant's site or Web “page.”

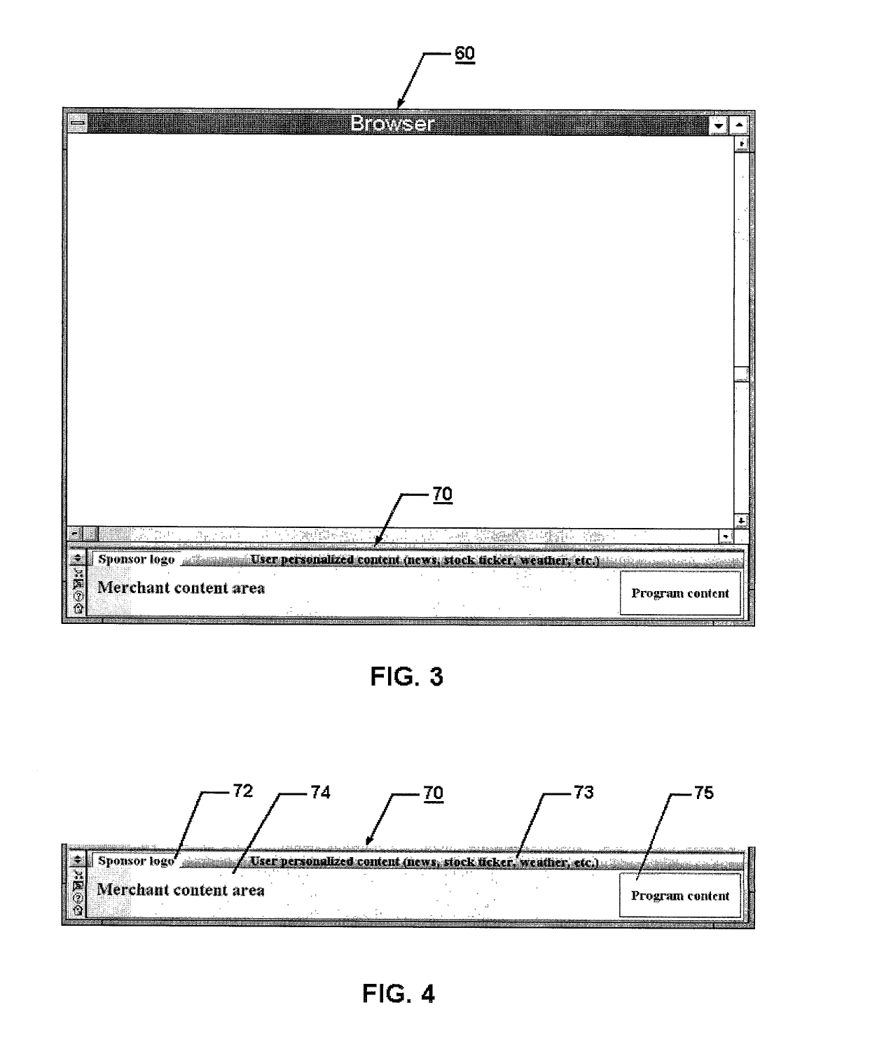

As illustrated in FIGS. 3 and 4, the browser extension 70 is preferably displayed on the client computer system 20 as a mini-browser within the “main” browser 60. The browser extension 70 is preferably fully configurable by the user of the client computer system 20 and may selectively appear in full height or fully expanded mode, short height mode, or hidden mode. The browser 60 and browser extension 70 may be displayed on a video display terminal, monitor or screen associated with the client computer system 20 via a graphical user interface (“GUI”). A GUI is a conventional type of display format that enables a user of the computer system to choose commands, start programs, and see lists of files and other options by pointing to pictorial representations (e.g., icons) and lists of menu items on the video display terminal, monitor or screen. Selections may generally be activated with either a keyboard or a mouse.

As discussed above, the browser extension 70 preferably provides the user with special, personalized content that can be displayed within the browser extension 70 on the user's client computer system 20. This special, personalized content may include information related to: (1) a participating merchant's site or Web “page”, (2) the nature of the customer loyalty rewards available under the customer loyalty reward program, (3) selectable, configurable and useful content such as news, sports, weather and stock information, and (4) other information that may be of interest to participants of the customer loyalty reward program. In addition, the browser extension 70 may provide the user with gentle reminders when the user visits a non-participating merchant's (“e-retailer”) site or “page” that rewards under the customer loyalty reward program are available at a specific participating merchant's site or “page.”

In the fully expanded mode as illustrated in FIGS. 3 and 4, the browser extension preferably includes a number of sections for display to the user, including a sponsor logo section 72, a user-selected content section 73, a merchant content section 74 and a program content section 75. The brand logo of the sponsor of the customer loyalty reward program (e.g., CIBC-Aerogold) may be displayed to the user in the sponsor logo section 72 of the browser extension 70. User-specified information (e.g., weather, news, stock ticker, etc.) may be displayed in the user-selected content section 73 of the browser extension 70. Welcome messages, customer loyalty reward information, specials, etc. may be displayed in the merchant content section 74 of the browser extension 70, and information related to the customer loyalty reward program as a whole may be displayed in the program content section 75 of the browser extension 70.

When the browser extension 70 is in short height mode (not shown), the browser extension 70 preferably displays only the sponsor logo and user selected content sections 72, 73. Similarly, when the browser extension 70 is in hidden mode (not shown), no content from the browser extension 70 is displayed on the user's client computer system 20. The user of the client computer system 20 may select the desired mode for displaying the browser extension 70 on the user's client computer system 20.

In the preferred embodiment of the present invention, the content area of the browser extension 70 is configurable and is approximately 70 pixels in height. Width of the browser extension 70 is preferably variable and dependant on the resolution of the video display terminal and the size the user has set for the browser 60 on the client computer system 20. Content may be developed and managed by the participating merchant (“e-merchant”) operating the merchant server computer system 30, or in partnership with the manager of the customer loyalty reward program operating the business server computer system 41 and/or sponsor of the customer loyalty reward program operating the sponsor server computer system 50.

Preferably, the browser extension 70 serves as a fully-functional “mini” web-browser that is capable of supporting all the features of conventional browser 60, such as HTML content; animated GIFs, browser plug-ins (e.g., ShockWave) and Java applets. The browser extension 70 is preferably a sophisticated browser extension that is able to monitor the user's navigation within the main browser 60 on the client computer system 20 and displays extended content within the browser extension 70 based on the sites or Web “pages” visited by the user.

In accordance with a preferred embodiment of the present invention, the browser extension 70 searches the content of HTML documents or “pages” displayed on the client computer system 20 and detects special text embedded in a comment block or “data island” of the HTML “page” being displayed on the client computer system 20. This special text is preferably written in Extensible Markup Language (“XML”), which is a conventional language for data on the WWW. XML, which was first published in or about November 1996, is a standardized formatting notation for representing data in on-line applications that is easy to create and process. Like HTML, XML is a simplification of the Standard Generalized Markup Language (“SGML”). Unlike HTML, however, XML allows application developers to use different Document Type Definitions (“DTDs”) to define application-specific tags. Thus, XML gives application developers the power to deliver structured data from a wide variety of applications to the client computer system 20 for local computation and presentation. XML allows the creation of unique data formats for specific applications and is an ideal format for server-to-server transfer of structured data.

A preferred manner for detecting this special text (e.g., XML) embedded within the HTML document is through the use of a parser (not shown) that functions with the browser 60 and/or browser extension 70 on the client computer system 20. An example of such as a parser suitable for operating with the present invention is the XML parser provided with the Microsoft® Internet Explorer 4.0 browser or Internet Explorer 5.0 browser, which reads and delivers the XML data to a local application, such as the browser extension 70, for further processing in accordance with the present invention.

Once the browser extension 70 is installed on the client computer system 20, the user of the client computer system 20 may navigate a site or Web “page” on the merchant server computer system 30 using either the browser 60 or the browser extension 70 to browse and select items for purchase over the network 10 (e.g., the Internet or WWW).

Several preferred embodiments of the present invention are described below. In one embodiment, XML or special text may be embedded in a comment block or data island of a HTML “page” to instruct the browser extension 70 to display predefined content (e.g., advertising, messages, etc.) on the client computer system 20 and/or to redirect the browser 60 on the client computer system 20 to a particular URL.

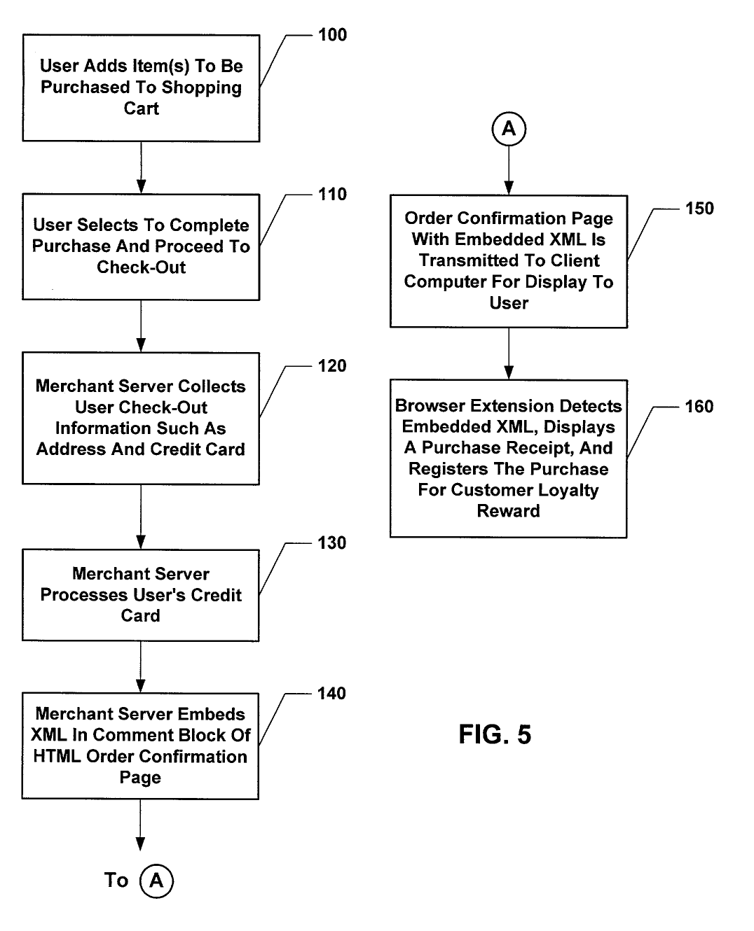

Referring now to the embodiment of the present invention illustrated in FIG. 5, the user of a client computer system 20—who has registered as a participant in the customer loyalty reward program and installed the browser extension 70 on the user's client computer system 20—may navigate and browse through the electronic catalog (i.e., the merchant's Web site offered by the merchant server computer system 30) using either the browser 60 or browser extension 70 installed on the client computer system 20. When the user selects an item to be purchased on-line from the merchant's electronic catalog or Web “page”, the merchant server computer system 30 preferably adds the selected item to a “shopping cart” created for the particular user (step 100).

Once the user has finished selecting items for purchase, the user of the client computer system 20 transmits a request to the merchant server computer system 30 to proceed to “check-out” (step 110). That is, all the items in the user's shopping cart are “checked out” (i.e., ordered) when the user of the client computer system 20 transmits user-specific billing and shipment information to the merchant server computer system 30 (step 120). This is commonly done by having the merchant server computer system 30 present the user of the client computer system 20 with a HTML order “page” that prompts the user to input user-specific order information to complete the purchase. This user-specific order information may include the user's name, the user's credit card number or other secured payment mechanism, and a shipping address for the order.

The merchant server computer system 30 preferably processes and validates the user's credit card number and other user-specific order information (step 130). Once the merchant server computer system 30 completes processing and validation of the user's credit card number, the merchant server computer system 30 preferably generates a dynamic HTML order confirmation “page” to be transmitted and displayed on the user's client computer system 20.

In addition, the merchant server computer system 30 also dynamically embeds special purchase-descriptive text (e.g., XML) in a comment block or “data island” of the dynamic HTML order confirmation “page” (step 140) for detection by the browser extension 70. In the preferred embodiment of the present invention, this embedded special text is written in XML in a comment block of the HTML order confirmation “page” and describes the user's on-line purchase that was just validated by the merchant server computer system 30. This embedded purchase-descriptive text may include the following information:

The unique identification number assigned to the merchant (“e-retailer”) in the customer loyalty reward program.

The merchant's unique internal transaction identification number generated by the merchant server computer system 30 to identify the transaction being processed.

The first six digits (“BIN”) of the user's credit card number.

The list of items being purchased by the user (product identification, and optionally, product description, quantity and price).

The agreed upon total dollar amount that the user's customer loyalty reward will be based upon.

Optionally, the currency of the transaction (e.g., U.S. dollars, Canadian dollars, etc.).

The HTML order confirmation “page” with the dynamically embedded XML or special text is then transmitted by the merchant server computer system 30 to the client computer system 20 for display to the user (step 150). By embedding the XML or other special text in a comment block of the HTML “page”, the browser extension 70 may detect and process the purchase information contained in the XML or other special text without affecting the ability of the browser 60 to display the HTML “page”.

The browser extension 70 installed on the client computer system 20 preferably detects the presence of the embedded XML or other special text in the HTML order confirmation “page” using a parser and processes the embedded XML or other special text to generate a purchase receipt on the client computer system 20 for display to the user (step 160). In addition, the browser extension 70 transmits the purchase information contained in the embedded XML or other special text to the business server computer system 41 via computer network 10 to register the user's purchase for a reward under the customer loyalty reward program. The business server computer system 41 may preferably store this transmitted purchase information in data storage device 42 for subsequent use in connection with the customer loyalty reward program.

In the above-described preferred embodiment, it is not necessary for the merchant server computer system 30 to know whether a user of a client computer system 20 is a participant in the customer loyalty reward program as long as the XML or other special text is embedded in each order confirmation “page” generated by the merchant server computer system 30. It is understood, however, that the browser extension 70 may provide a flag or other identifier that is detectable by the merchant server computer system 30 to identify a user of a client computer system 20 as a participant in the customer loyalty reward program. This may be accomplished, for example, by the having the browser extension 70 modify the navigational URL to the merchant's site or Web “page” to add one or more parameters that may be detected by the merchant server computer system 30. In this manner, the merchant server computer system 30 might only generate the dynamically embedded XML or other special text upon detection of the flag indicative of a participant in the customer loyalty reward program.

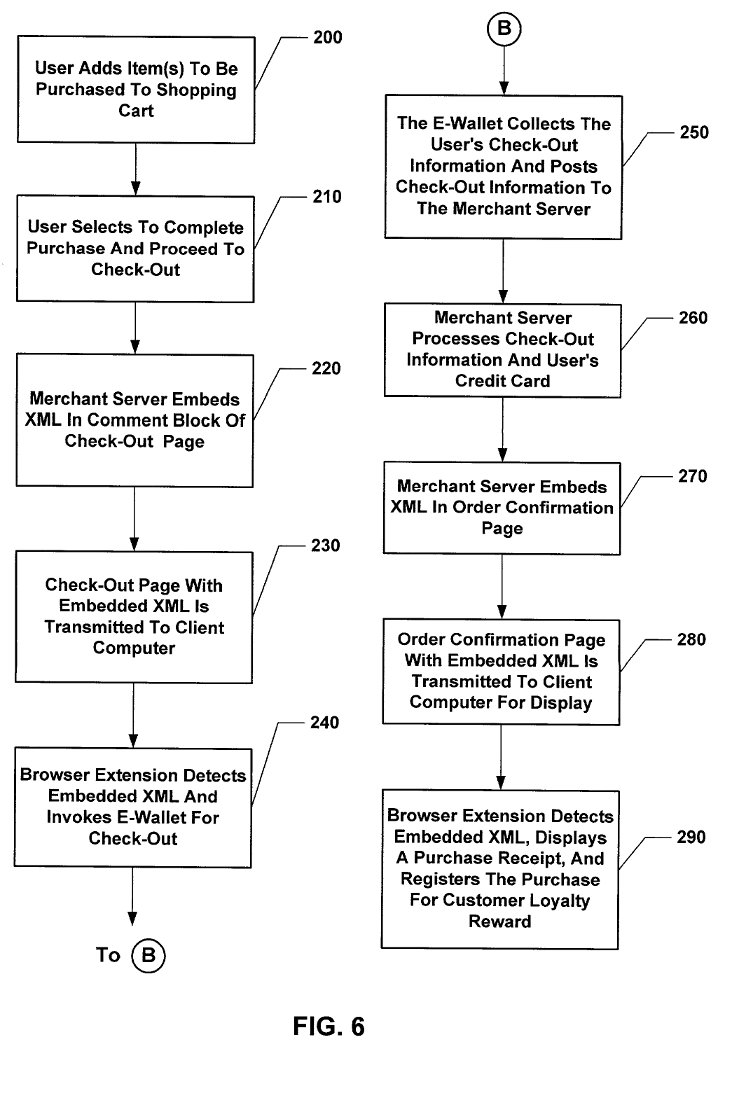

In a second preferred embodiment of the present invention illustrated in FIG. 6, the browser extension 70 not only serves to manage and register on-line purchases for the customer loyalty reward program, but also functions as an “e-Wallet” to collect the user-specific information during the purchase or check-out process for posting to the merchant server computer system 30. As with the above-described embodiment, the user of a client computer system 20—who has registered as a participant in the customer loyalty reward program and installed the browser extension 70 on the user's client computer system 20—may navigate and browse through the merchant's Web site or “page” offered by the merchant server computer system 30 using either the browser 60 or browser extension 70 installed on the client computer system 20. When the user of the client computer system 20 selects an item to be purchased on-line from the merchant's Web “page”, the merchant server computer system 30 preferably adds the selected item to a “shopping cart” created for the particular user (step 200). Once the user has finished selecting items for purchase, the user of the client computer system 20 transmits a request to the merchant server computer system 30 to proceed to “check-out” (step 210).

In this second preferred embodiment of the present invention, the merchant server computer system 30 dynamically embeds purchase-descriptive XML or other special text describing the items selected by the user for purchase in a comment block or “data island” of the initial HTML “page” that is part of the merchant's normal check-out procedure (step 220). It is understood that the merchant may select another HTML “page” other than the initial check-out “page” for embedding the XML or other special text. This embedded XML or special text preferably describes the user's purchase, which preferably may include the following information:

The unique identification number assigned to the merchant (“e-retailer”) in the customer loyalty reward program.

The merchant's unique internal transaction identification number generated by the merchant server computer system 30 to identify the transaction being processed.

The subtotal dollar amount of the user's purchase order before any taxes and shipping.

The list of items being purchased by the user (product identification, and optionally, product description, quantity and price).

Shipping options and costs.

Any applicable tax rules.

Optionally, the currency of the transaction (e.g., U.S. dollars, Canadian dollars, etc.).

The merchant server computer system 30 transmits the HTML check-out “page” with the dynamically embedded purchase-descriptive XML or special text over network 10 to the client computer system 20 (step 230). The browser extension 70 installed on the client computer system 20 detects the presence of the embedded XML or other special text in the HTML check-out “page” preferably using a parser and directs the browser 60 to a display a predefined standby screen on the client computer system 20 (step 240). The browser extension 70 thereafter launches and displays a “window” on the client computer system 20 to provide the user with the ability to input user-specific purchase information, such as the user's name and address, credit card number and shipping information (step 250).

The “e-Wallet” function of the browser extension 70 presents a consistent check-out interface to the user of the client computer system 20 at all merchant server computer systems that participate in the customer loyalty reward program. The user of the client computer system 20 need only input the user-specific information once and the browser extension 70 and/or the business server computer system 41 stores the information for use by the user in subsequent purchases. For example, the “e-Wallet” function of the browser extension 70 may utilize an address book previously created by the user to select a destination address. In addition, the “e-Wallet” function of the browser extension 70 may allow cardholders (e.g., parents) to set up additional accounts under the cardholder's account to permit other authorized persons (e.g., children) to make secure purchases using the cardholder's credit card, with the ability to establish monthly purchase limits and control the type or categories of merchandise to be purchased.

Once the user of client computer system 20 approves the purchase and has input the user-specific purchase information, the browser extension 70 generates and transmits a HTML form post to a web “page” designated by the participating merchant on the merchant server computer system 30 (step 250). The embedded purchase-descriptive XML or other special text that triggered the browser extension 70 should preferably contain the URL to the “page” on the merchant server computer system 30 where the HTML form will post. The HTML form post can be processed by the merchant server computer system 30 in the same manner as form submissions from a Web “page” (e.g., ASP programming using VBScript) and the HTML form post will act as if a Web “page” containing the equivalent of the HTML form post was posted to the merchant's Web site.

Having detected and received the HTML form post from the browser extension 70 on the client computer system 20, the merchant server computer system 30 identifies and registers the on-line purchase as being from a participant of the customer loyalty reward program. Because it is possible that some, but not all, purchases by a user may qualify for a customer loyalty reward, it is preferable that the browser extension 70 and/or merchant server computer system 30 flag the individual transactions, rather than the user-specific information, as related to the customer loyalty reward program to accurately generate order activity reports.

The HTML form posted to the merchant server computer system 30 may contain the following information:

The unique transaction identifier associated with the customer loyalty reward program.

The merchant's unique transaction identifier that was previously embedded in the purchase-descriptive XML or other special text.

The user's name and address.

The user's credit card number.

The name embossed on the user's credit card.

The expiration date embossed on the user's credit card.

The billing address and telephone number.

The shipping address.

The shipping method selected by the user.

The total dollar amount of the purchase.

Contact information (e.g., e-mail address) for the user and recipient (if not the user).

To minimize the possibility that a HTML form post to merchant server computer system 30 may not be authentic, the browser extension 70 may provide some form of security or authentication within the HTML form post by, for example, including in the HTML form post the merchant's unique transaction identification number previously specified in the embedded purchase-descriptive XML received from the merchant server computer system 30. Other means of security may also be utilized, such as encryption or real-time security verification where an application running on the merchant server computer system 30 contacts the business server computer system 41 to exchange verification information (e.g., XML).

Once the merchant server computer system 30 receives the HTML form post from browser extension 70 operating on the client computer system 20 (and satisfies any security in place to authenticate the HTML form post), the merchant server computer system 30 processes the user-specific purchase information contained in the received HTML form post, including processing/validating the user's credit card number (step 260).

If the user-specific purchase information and credit card number process properly, the merchant server computer system 30 preferably generates a HTML order confirmation “page” with XML or other special text dynamically embedded in a comment block or “data island” to describe the items selected by the user for purchase (step 270). The embedded XML or other special text may contain purchase-descriptive information similar to that described in step 140 of the previously-described embodiment.

The HTML order confirmation “page” with the dynamically embedded XML or special text is then transmitted by the merchant server computer system 30 to the client computer system 20 for display to the user (step 280). By preferably embedding the XML or other special text in a comment block of the HTML “page”, the browser extension 70 may detect and process the purchase information contained in the XML or other special text without affecting the ability of the browser 60 to display the HTML “page”.

The browser extension 70 installed on the client computer system 20 preferably detects the presence of the embedded XML or other special text in the HTML order confirmation “page” using a parser and processes the embedded XML or other special text to generate a purchase receipt on the client computer system 20 for display to the user (step 290). In addition, the browser extension 70 transmits the purchase information contained in the embedded XML or other special text to the business server computer system 41 via computer network 10 to register the user's purchase for a reward under the customer loyalty reward program (step 290). The business server computer system 41 may preferably store this transmitted purchase information in data storage device 42 for subsequent use in connection with the customer loyalty reward program.

In either of the above-described embodiments, the merchant server computer system 30 may preferably communicate with the business server computer system 41 over computer network 10 for the purpose of administering and managing the customer loyalty reward program. Information relating to a participating user's registered on-line purchases is preferably maintained and updated in the data storage device 42 associated with the business server computer system 41. In addition, reports identifying a participating merchant's sales registered under the customer loyalty reward program may be transmitted manually and/or automatically by the business server computer system 41 to the merchant server computer system 30. Similarly, a participating merchant may correct a previously registered purchase to account for post-purchase activities (e.g., refunds, back-order shipments, cancellations, etc.) by transmitting such changes from the merchant server computer system 30 to the business server computer system 41 over network 10. The business server computer system 41 will thereafter update the previously registered purchase to account for the post-purchase activity and store the updated purchase information in the data storage device 42.

The user of the client computer system 20 may also communicate with the business server computer system 41 over network 10 to obtain status information (e.g., points earned, rewards available, rules for participating in the program, etc.) regarding the user's participation in the customer loyalty reward program. In addition, reports regarding the user's participation in the program may be transmitted from the business server computer system 41 to the client computer system 20 over network 10.

Similarly, the business server computer system 41 may communicate with the sponsor server computer system 50 over network 10 for the purpose of administering the sponsor's customer loyalty reward program. In this manner, reports or data regarding participation in the customer loyalty reward program may be transmitted from the business server computer system 41 to the sponsor computer system 50 over network 10.

### e-Coupon Application

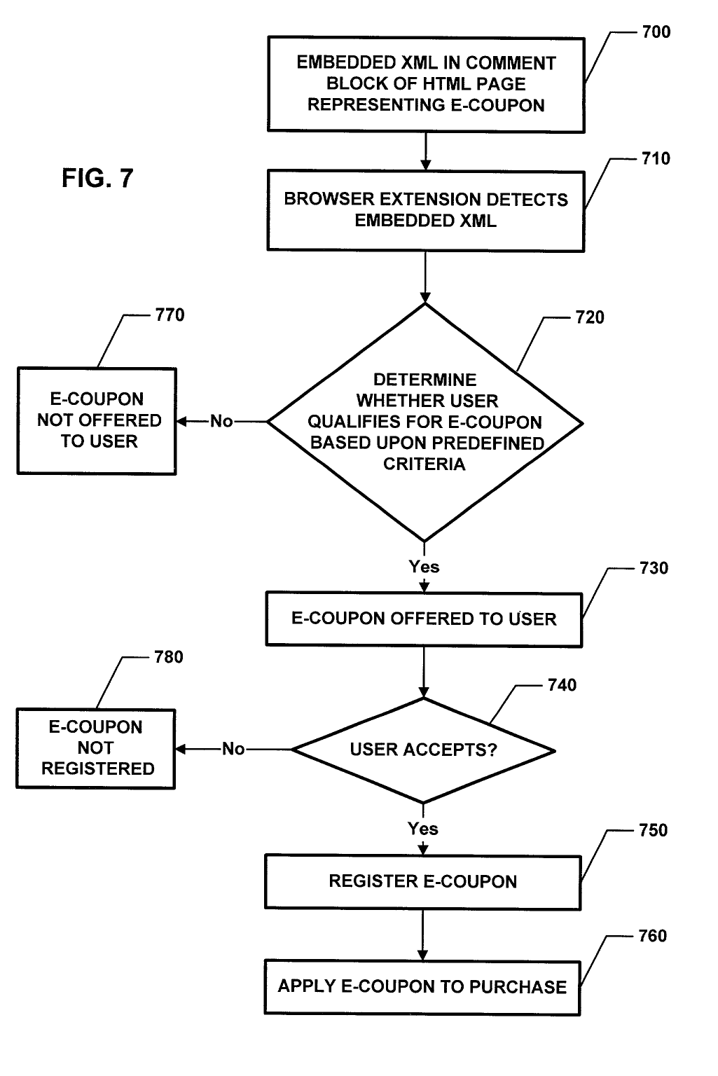

It is understood that the present invention is not limited to the abovedescribed preferred embodiments and that the browser extension 70 may be utilized in connection with other applications. For instance, referring to FIG. 7, the present invention may be utilized in the context of processing electronic coupons, instantaneous rewards, or other promotions (collectively referred to hereinafter as “e-Coupons”) over the Internet, intranet or other computer/communication network 10. One example of an e-Coupon could be an offer to award a participant in a customer loyalty reward program bonus “points” or “miles” for purchasing particular goods or services from participating merchants. Another example could be to provide a participant in the customer loyalty reward program with a discount for purchasing particular goods or services from participating merchants.

In accordance with the present invention, the e-Coupons may be represented by XML or special text embedded in a HTML “page” that may be detected by the browser extension 70 installed on a client computer system 20 (as discussed above) to register and/or process the e-Coupon. In a preferred embodiment of the present invention, a manufacturer, merchant or other entity participating in the customer loyalty reward program may offer one or more e-Coupons to consumers by embedding (statically or dynamically) special text (e.g., XML) describing the e-Coupon in a comment block or “data island” of a desired HTML “page” on a server computer system (e.g., server computer system 30) (step 700). It is understood, however, that the e-Coupon may be embedded in a HTML “page” on other computer systems accessible to the client computer system 20, such as server computer systems 31, 32, 41, 43 or 50 illustrated in FIG. 1. The embedded text describing the e-Coupon may include a coupon identification, a product identification, any purchase restrictions, any merchant restrictions, and the value of the e-Coupon including currency, as well as information used to authenticate the e-Coupon.

A user of a client computer system 20—who has registered as a participant in the customer loyalty reward program and installed the browser extension 70 on the user's client computer system 20—may navigate and browse through the Web site or “page” of the particular manufacturer, merchant or other entity offering the e-Coupon using either the browser 60 or browser extension 70 installed on the client computer system 20. The HTML “page” with the embedded XML or special text is transmitted by the server computer system 30 to the client computer system 20 and the browser extension 70 installed on the client computer system 20 detects the presence of the embedded XML or other special text in the HTML “page” preferably using a parser (step 710).

It is understood that a user of a client computer system 20, 21, 22, who has not installed the browser extension 70, may not be aware of the e-Coupon being offered to participants in the customer loyalty reward program when viewing the HTML “page” unless the e-Coupon is also displayed on the “page.” It is not necessary, however, to display the e-Coupon on the HTML “page”, but rather to represent the e-Coupon by embedding XML or other special text in a comment block or “data island” of the “page” for detection and processing by the browser extension 70.

Once the browser extension 70 detects the embedded XML or other special text describing the e-Coupon, the browser extension 70 preferably transmits a request over the network 10 to the business server computer system 41 (or, alternatively, the web server computer system 43) to determine whether, based on a variety of predetermined criteria, the e-Coupon should be offered to the particular user of the client computer system 20 (step 720). This predetermined criteria may include pre-established restrictions over whom the e-Coupon may be offered to (e.g., country or geographic location of the user, date, time of day, prior purchase history, or other personal information consented to by the user for use in determining available promotions). In this manner, it is possible for a manufacturer, merchant or other entity to define those users to whom the e-Coupon should be offered to by limiting distribution of the e-Coupon to users.

If the user qualifies for the e-Coupon, the business server computer system 41 (or, alternatively, the web server computer system 43) transmits a response, preferably in the form of XML or other special text, over network 10 instructing the browser extension 70 to offer the e-Coupon to the user (step 730). This may be accomplished by preferably instructing the browser extension 70 to request a specific URL associated with a HTML “page” containing the e-Coupon details to display that “page” on the user's client computer system 20. The user of the client computer system 20 may then select the e-Coupon that the user wishes to accept in a conventional manner (e.g., using an input device on the client computer system 20 to transmit the acceptance to the server computer system 30 and/or business server computer system 41) (step 740).

Once the user of the client computer system 20 accepts one or more of the displayed e-Coupons, the accepted e-Coupons are registered with the business server computer system 41 by preferably storing the details associated with the e-Coupon for that particular user in data storage device 42 for subsequent use by the registered user of the client computer system 20 (step 750). The data storage device 42 may be constructed as a virtual e-Coupon pouch that is accessible to the user of the client computer system 20 over network 10 to permit the user to display the user's registered e-Coupons on the client computer system 10, along with a list of merchants where the user may redeem the e-Coupon.

Thereafter, when the user of the client computer system 20 makes a qualifying on-line purchase, the browser extension 70 detects and processes the embedded purchase-descriptive text (e.g., XML) as discussed above in the preceding embodiments (see FIGS. 5 & 6) to register the purchase with the business server computer system 41. The business server computer system 41 determines whether the user has registered any applicable e-Coupons by searching the information for the particular user stored in the data storage device 42.

If an applicable, registered e-Coupon is identified for that user, the business server computer system 41 may either automatically apply the e-Coupon to the user's registered on-line purchase, or alternatively, the business server computer system 41 may transmit a query to the user of the client computer system 20 to determine whether the user wishes to apply the e-Coupon to the purchase (step 760). Once the e-Coupon is applied, the business server computer system 41 may preferably cause the re-cord associated with that e-Coupon to be deleted from the data storage device 42 for that particular user.

It is understood that e-Coupons available as part of the customer loyalty reward program may be displayed on a HTML “page” associated with the web server computer system 43 or another server computer system. A user of the client computer system 20 may request this “page” from the web server computer system 43 and display the “page” containing available e-Coupons on the user's client computer system 20. The user of the client computer system 20 may select one or more e-Coupons that the user wishes to accept in a conventional manner (e.g., using an input device on the client computer system 20 to transmit the acceptance to the web server computer system 43) and, if it is determined that the user qualifies for the e-Coupon (as discussed above in step 720), then the accepted e-Coupons may be registered with the business server computer system 41 by preferably storing the details associated with the e-Coupon for that particular user in data storage device 42 for subsequent use by the registered user of the client computer system 20.

The browser extension 70 on the user's client computer system 20 may also serve to remind the user of the existence of one or more registered e-Coupons in the user's e-Coupon pouch. The browser extension 70 may monitor the particular URL for the “page” currently displayed on the user's client computer system 20, and, if the URL matches that contained in a predefined list of URLs corresponding to the registered e-Coupon, then the browser extension 70 may display that e-Coupon on the client computer system 20 or otherwise remind the user of the existence of the e-Coupon.

It is also understood that the user of client computer system 20 may print a hard copy of the registered e-Coupon or obtain a hard copy of the registered e-Coupon from the entity administering the customer loyalty reward program. The hard copy of the registered e-Coupon could then be used as a traditional coupon, instead of using the e-Coupon in connection with an on-line purchase of goods or services.

Although illustrative preferred embodiments have been described herein in detail, it should be noted and will be appreciated by those skilled in the art that numerous variations may be made within the scope of this invention without departing from the principle of this invention and without sacrificing its chief advantages. The terms and expressions have been used herein as terms of description and not terms of limitation. There is no intention to use the terms or expressions to exclude any equivalents of features shown and described or portions thereof, and this invention should be defined in accordance with the claims that follow.

We claim:

1. A method for administering an on-line customer loyalty reward program, comprising:
receiving a HyperText Markup Language (“HTML”) document with purchase-descriptive text embedded within a comment block;
detecting the purchase-descriptive text; and
processing the purchase-descriptive text to register an on-line purchase in the customer loyalty reward program.

2. The method according to claim 1, wherein the purchase-descriptive text is written in Extensible Markup Language (“XML”).

3. The method according to claim 2, wherein a browser extension installed on a client computer system detects and processes the purchase-descriptive text.

4. The method according to claim 3, wherein the browser extension detects the purchase-descriptive text using a parser.

5. The method according to claim 3, wherein the HTML document with embedded purchase-descriptive text is an order confirmation page generated by a server computer system for an item to be purchased by the user of a client computer system.

6. The method according to claim 5, wherein the embedded purchase-descriptive text includes a unique identification number assigned to a merchant participating in the customer loyalty reward program.

7. The method according to claim 5, wherein the embedded purchase-descriptive text identifies the item purchased by the user and a purchase price for the item.

8. The method according to claim 5, comprising:
communicating with the server computer system to receive and display an item to be purchased by the user on a client computer system;
selecting the item to be purchased by the user and transmitting a request to the server computer system to purchase the item; and
transmitting user-specific order information to the server computer system.

9. The method according to claim 8, wherein the user-specific order information is stored by the browser extension for subsequent transmission to the server computer system upon detection of the purchase-descriptive text embedded within a comment block of a HTML check-out document.

10. The method according to claim 8, wherein the user-specific order information is input by the user of the client computer system.

11. The method according to claim 8, comprising processing and validating the user-specific order information.

12. The method according to claim 5, comprising receiving and displaying the HTML document on the user's client computer system.

13. The method according to claim 5, wherein the browser extension processes the embedded purchase-descriptive text to generate a purchase receipt on the client computer system for display to the user.

14. The method according to claim 5, wherein the browser extension transmits information contained within the embedded purchase-descriptive text to a business server computer system to register the user for a reward under the customer loyalty reward program based on the purchase information contained within the embedded purchase-descriptive text.

15. The method according to claim 14, further comprising storing the transmitted information for subsequent use in connection with the customer loyalty reward program.

16. The method according to claim 5, wherein the browser extension transmits an identifier to the server computer system to identify the user of the client computer system as a participant in the customer loyalty reward program, and wherein the purchase-descriptive text is embedded in the HTML document upon detection of the identifier indicative that the user is a participant in the customer loyalty reward program.

17. The method according to claim 3, wherein personalized content is displayed within the browser extension on the user's client computer system.

18. The method according to claim 17, wherein the personalized content includes information concerning a participating merchant's web site.

19. The method according to claim 17, wherein the personalized content includes information concerning the nature of the customer loyalty rewards available under the customer loyalty reward program.

20. The method according to claim 17, wherein the personalized content includes user-defined content.

21. A system for administering an on-line customer loyalty reward program, comprising:
a network;
a server computer system connected to the network and adapted to embed purchase-descriptive text within a comment block of a HyperText Markup Language (“HTML”) document to be displayed on a client computer system connected to the network; and
a browser extension installed on the client computer system to detect and process the purchase-descriptive text to register an on-line purchase in the customer loyalty reward program.

22. The system according to claim 21, wherein the purchase-descriptive text is written in Extensible Markup Language (“XML”).

23. The system according to claim 22, wherein the browser extension detects the purchase-descriptive text using a parser.

24. The system according to claim 23, wherein the HTML document with embedded purchase-descriptive text is an order confirmation page generated by the server computer system for an item to be purchased by the user of the client computer system.

25. The system according to claim 24, wherein the embedded purchase-descriptive text includes a unique identification number assigned to a merchant participating in the customer loyalty reward program.

26. The system according to claim 24, wherein the embedded purchase-descriptive text identifies the item purchased by the user and a purchase price for the item.

27. The system according to claim 24, wherein the client computer system communicates with the server computer system to display an item to be purchased by the user on the client computer system, and transmits a request and user-specific order information to the server computer system to purchase the item.

28. The system according to claim 27, further comprising a database operably connected to the browser extension for storing the user-specific order information for subsequent transmission to the server computer system upon detection of the purchase-descriptive text embedded within a comment block of a HTML check-out document.

29. The system according to claim 27, wherein the user-specific order information is input by the user of the client computer system.

30. The system according to claim 27, wherein the server computer system is adapted to process and validate the user-specific order information.

31. The system according to claim 24, wherein the HTML document is displayed on the user's client computer system.

32. The system according to claim 24, wherein the browser extension processes the embedded purchase-descriptive text to generate a purchase receipt on the client computer system for display to the user.

33. The system according to claim 24, further comprising a business server computer system connected to the network, wherein the browser extension transmits information contained within the embedded purchase-descriptive text to the business server computer system to register the user for a reward under the customer loyalty reward program based on the purchase information contained within the embedded purchase-descriptive text.

34. The system according to claim 33, further comprising a database operably connected to the business server computer system for storing the transmitted information for subsequent use in connection with the customer loyalty reward program.

35. The system according to claim 24, wherein the browser extension transmits an identifier to the server computer system to identify the user of the client computer system as a participant in the customer loyalty reward program, and wherein the server computer system embeds the purchase-descriptive text in the HTML document upon detection of the identifier indicative that the user is a participant in the customer loyalty reward program.

36. The system according to claim 21, wherein personalized content is displayed within the browser extension on the client computer system.

37. The system according to claim 36, wherein the personalized content includes information concerning a participating merchant's web site.

38. The system according to claim 36, wherein the personalized content includes information concerning the nature of the customer loyalty rewards available under the customer loyalty reward program.

39. The system according to claim 36, wherein the personalized content includes user-defined content.

40. A system for administering an on-line customer loyalty reward program, comprising:
a network;
a server computer system connected to the network for embedding purchase-descriptive text within a comment block of a HyperText Markup Language (“HTML”) document to be displayed on a client computer system connected to the network; and
means for detecting and processing the purchase-descriptive text to register an on-line purchase in the customer loyalty reward program.

41. The system according to claim 40, wherein the purchase-descriptive text is written in Extensible Markup Language (“XML”).

42. The system according to claim 40, wherein the means for detecting and processing the purchase-descriptive text comprises a browser extension installed on the client computer system.

43. The system according to claim 42, wherein the browser extension detects the purchase-descriptive text using a parser.

44. The system according to claim 42, further comprising a business server computer system connected to the network, wherein the browser extension transmits information contained within the embedded purchase-descriptive text to the business server computer system to register the user for a reward under the customer loyalty reward program based on the purchase information contained within the embedded purchase-descriptive text.

45. The system according to claim 44, further comprising a database operably connected to the business server computer system for storing the transmitted information for subsequent use in connection with the customer loyalty reward program.

46. The system according to claim 42, further comprising a database operably connected to the browser extension for storing user-specific order information for subsequent transmission to the server computer system upon detection of the purchase-descriptive text embedded within a comment block of a HTML document.

47. The system according to claim 41, wherein the embedded purchase-descriptive text includes a unique identification number assigned to a merchant participating in the customer loyalty reward program.

48. The system according to claim 41, wherein the embedded purchase-descriptive text identifies an item purchased by the user and a purchase price for the item.

49. A method for distributing, registering and redeeming an electronic coupon (“e-Coupon”), comprising:
embedding text within a comment block of a HyperText Markup Language (“HTML”) document, the embedded text identifying and describing the e-Coupon;
receiving data representing the HTML document and embedded text at a user's computer system;
detecting the embedded text; and
processing the embedded text to register the e-Coupon for the user in a database.

50. The method according to claim 49, wherein the embedded text is written in Extensible Markup Language (“XML”).

51. The method according to claim 49, wherein a browser extension installed on the user's computer system detects and processes the embedded text.

52. The method according to claim 49, further comprising determining whether the user qualifies for the e-Coupon and offering the e-Coupon to the user before registering the e-Coupon in the user's account.

53. The method according to claim 52, further comprising accepting the e-Coupon by the user before registering the e-Coupon in the user's account.

54. The method according to claim 49, further comprising:
detecting an on-line purchase by the user;
determining whether the user has registered an applicable e-Coupon; and
applying the registered e-Coupon to the on-line purchase by the user.

55. The method according to claim 54, wherein the step of detecting an on-line purchase by the user comprises:
embedding purchase-descriptive text within a comment block of a HTML order confirmation document;
detecting the purchase-descriptive text; and
processing the purchase-descriptive text to register an on-line purchase in the customer loyalty reward program.

56. The method according to claim 55, wherein the purchase-descriptive text is written in XML.

57. The method according to claim 55, wherein a browser extension installed on the user's computer system detects and processes the purchase-descriptive text.

58. A system for detecting, registering and redeeming an electronic coupon (“e-Coupon”), comprising:
a server computer system connected to a network and adapted to embed text within a comment block of a HyperText Markup Language (“HTML”) document to be displayed on a user's client computer system connected to the network, the embedded text identifying and describing the e-Coupon; and
a browser extension installed on the user's client computer system adapted to detect and process the embedded text to register the e-Coupon for the user in a database.

59. The system according to claim 58, wherein the embedded text is written in Extensible Markup Language (“XML”).

60. The system according to claim 59, wherein the browser extension determines whether the user qualifies for the e-Coupon and offers the e-Coupon to the user before registering the e-Coupon in the user's account.

61. The system according to claim 58, wherein the browser extension detects an on-line purchase by the user, determines whether the user has registered an applicable e-Coupon, and applies the registered e-Coupon to the on-line purchase by the user.

62. The system according to claim 61, wherein the server computer system embeds purchase-descriptive text within a comment block of a HTML order confirmation document, and the browser extension detects the purchase-descriptive text.

63. The system according to claim 62, wherein the browser extension detects the purchase-descriptive text using a parser.

64. The system according to claim 62, wherein the browser extension processes the purchase-descriptive text to register an on-line purchase in a customer loyalty reward program.

65. The method according to claim 62, wherein the purchase-descriptive text is written in XML.

66. The system according to claim 64, further comprising a business server computer system connected to the network, wherein the browser extension transmits information contained within the embedded purchase-descriptive text to the business server computer system to register the user for a reward under the customer loyalty reward program based on the purchase information contained within the embedded purchase-descriptive text.

67. The system according to claim 66, further comprising a database operably connected to the business server computer system for storing the transmitted information for subsequent use in connection with the customer loyalty reward program.

68. The system according to claim 65, wherein the embedded purchase-descriptive text includes a unique identification number assigned to a merchant participating in the customer loyalty reward program.

69. The system according to claim 65, wherein the embedded purchase-descriptive text identifies an item purchased by the user and a purchase price for the item.
